(19) United States
(12) Patent Application Publication
(10) Pub. No.: US 2021/0039979 A1
(43) Pub. Date: Feb. 11, 2021

(54) DEVICE FOR ALIGNING AN IMPACT OF A TUBULAR PREFORM OF AN OPTICAL WAVEGUIDE

(71) Applicant: LEONI KABEL GMBH, NUERNBERG (DE)

(72) Inventors: CHRISTIAN SCHULZE, JENA (DE); WOLFGANG HAEMMERLE, JENA (DE)

(73) Assignee: LEONI KABEL GMBH, NUERNBERG (DE)

(21) Appl. No.: 16/978,194

(22) PCT Filed: Feb. 26, 2019
(86) PCT No.: PCT/DE2019/200017

§ 371 Date: Sep. 4, 2020

(30) Foreign Application Priority Data
Mar. 7, 2018 (DE) 10 2018 105 282.0

(51) Int. Cl. C03B 37/018

(52) U.S. Cl. CPC C03B 37/01861; C03B 37/01815

(57) ABSTRACT

A device for aligning an impact of a tubular preform of an optical waveguide. The device incudes a turning device which rotates the preform about an axis of rotation, a reactive gas supply which supplies a reactive gas to an inside of the preform, a burner device which is movably associated with the preform in a longitudinal direction along the axis of rotation of the preform and which control a temperature of an outer surface of the preform via a coating flame so that the reactive gas is partially deposited from the inside on an inner wall of the preform and melted to form a transparent layer, and an impact correction device having a compressed air device which applies compressed air. The impact correction device is arranged at a first longitudinal distance along the longitudinal direction from the coating flame so that the preform is aligned via the compressed air.

### CROSS REFERENCE TO PRIOR APPLICATIONS

This application is a U.S. National Phase application under 35 U.S.C. § 371 of International Application No. PCT/DE2019/200017, filed on Feb. 26, 2019 and which claims benefit to German Patent Application No. 10 2018 105 282.0, filed on Mar. 7, 2018. The International Application was published in German on Sep. 12, 2019 as WO 2019/170201 A1 under PCT Article 21(2).

### FIELD

The present invention relates to a device for aligning an impact of a tubular preform of an optical waveguide with a turning device, which imparts a rotation to the preform about an axis of rotation, a reactive gas supply, which supplies a reactive gas inside the preform, a burner device, which is associated so as to be displaceable in a longitudinal direction along the axis of rotation of the preform and applies a temperature to an outer surface of the preform via a coating flame so that the reactive gas is partially deposited from the inside on an inner wall of the preform and melted to form a transparent layer, and a method for correcting the impact of a preform via a compressed air device.

### BACKGROUND

In preform production using the MCVD process (MCVD=Modified Chemical Vapor Deposition), a glass tube is clamped in a glassmaker's turning lathe and locally partially heated from the outside by an oxyhydrogen gas burner over the tube length to approximately 1,800° C. to 2,000° C. The oxyhydrogen gas burner thereby moves at a predetermined speed of about 10 to 20 cm/min from the tube inlet, where the reactive gases flow into the tube, to the tube end. At the end of the tube, the burner is brought down to a lower temperature of about 400° C., and the burner then moves back to the tube inlet at a relatively high speed.

The burner temperature is there again raised to the point where the reactive gases react and glass soot is formed, which is deposited on the tube wall downstream of the hot burner zone by thermophoresis and is then melted into a transparent layer by the following hot zone.

This coating cycle is repeated during core deposition until the required core cross-sectional area is coated. The burner temperature is again increased significantly to approximately 2,200° C. to 2,300° C. so that the internally coated tube collapses into a solid rod due to its surface tension.

The glass tube rotates around its longitudinal axis with the aim of providing a uniform heating during all these processing steps.

A non-ideal adjustment of the tailstocks of the glassmaker's turning lathe, a non-ideal adjustment of the burner in relation to the tube axis, inadequacies of the substrate tube used (e.g., bow or siding), or a non-ideal positioning of the tube in the glassmaker's turning lathe lead to the gradual formation of a tube impact in the hot zone of the burner during core deposition.

A tube impact (also known as impact) is the deviation of the center point and thus the rotational axis of the tube cross-section at a certain axial position from the ideal rotational axis (for example, the rotational axis of the glassmaker's turning lathe). This deviation is generally dependent on the longitudinal position, so that any axial impact courses can develop between the points at which the tube is clamped. This course over the length of the tube can vary systematically or randomly from preform to preform.

The prior art has previously described that the tube impact is measured by laser scanner, displayed on a monitor, and recorded in a file. If the tube impact exceeds a defined tube length at any point on the substrate tube, a plant operator manually reduces the tube impact.

To this end, the plant is generally opened when the main burner starts at the tube inlet, and the plant operator reduces the tube impact by hand torches and graphite rollers by placing rollers underneath the locations of the largest tube impact and locally partially heating the tube at the beginning, end or, if necessary, in between and “pressing” the impact out of the tube as far as possible using the graphite rollers. This procedure for impact correction is carried out at several tube positions. After removing the graphite rollers and the hand burner, the enclosure of the glassmaker's turning machine is closed and the coating process is continued.

By opening the enclosure of the glassmaker's turning lathe, the substrate tube cools down more than when the enclosure is closed. This changes the glass soot deposition conditions downstream of the main burner and both the glass soot doping and the thickness of the individual layers can change.

During impact formation, individual layers with different dopings and thicknesses are also deposited over the tube circumference due to the different temperatures over the pipe circumference. These individual layers, which differ in the azimuthal direction, lead to azimuthal refractive index defects and thus to azimuthal profile defects.

The refractive index profile is also uneven in the longitudinal direction due to the axial dependence of the impact. These profile defects limit the bandwidths that can be achieved with the fibers and thus reduce their transmission capacity.

The manual straightening process also depends on the experience of the system operator.

### SUMMARY

An aspect of the present invention is to improve upon the prior art.

In an embodiment, the present invention provides a device for aligning an impact of a tubular preform of an optical waveguide. The device incudes a turning device which is configured to rotate the preform about an axis of rotation, a reactive gas supply which is configured to supply a reactive gas to an inside of the preform, a burner device which is configured to be movably associated with the preform in a longitudinal direction along the axis of rotation of the preform and to control a temperature of an outer surface of the preform via a coating flame so that the reactive gas is partially deposited from the inside on an inner wall of the preform and melted to form a transparent layer, and an impact correction device comprising a first compressed air device which is configured to apply compressed air. The impact correction device is arranged at a first longitudinal distance along the longitudinal direction from the coating flame so that the preform is aligned via the compressed air applied by the first compressed air device.

### BRIEF DESCRIPTION OF THE DRAWINGS

The present invention is described in greater detail below on the basis of embodiments and of the drawings in which:

FIG. 1 shows a schematic sectional view of a preform clamped in a glassmaker's turning lathe with a shown lateral impact and arranged air nozzles for impact correction;

FIG. 2 shows a schematic lateral view of a glassmaker's turning lathe with an impact correction device; and

FIG. 3 shows a schematic sectional view of a preform clamped in a glassmaker's turning lathe with a shown vertical impact and a pulsed air nozzle disposed above.

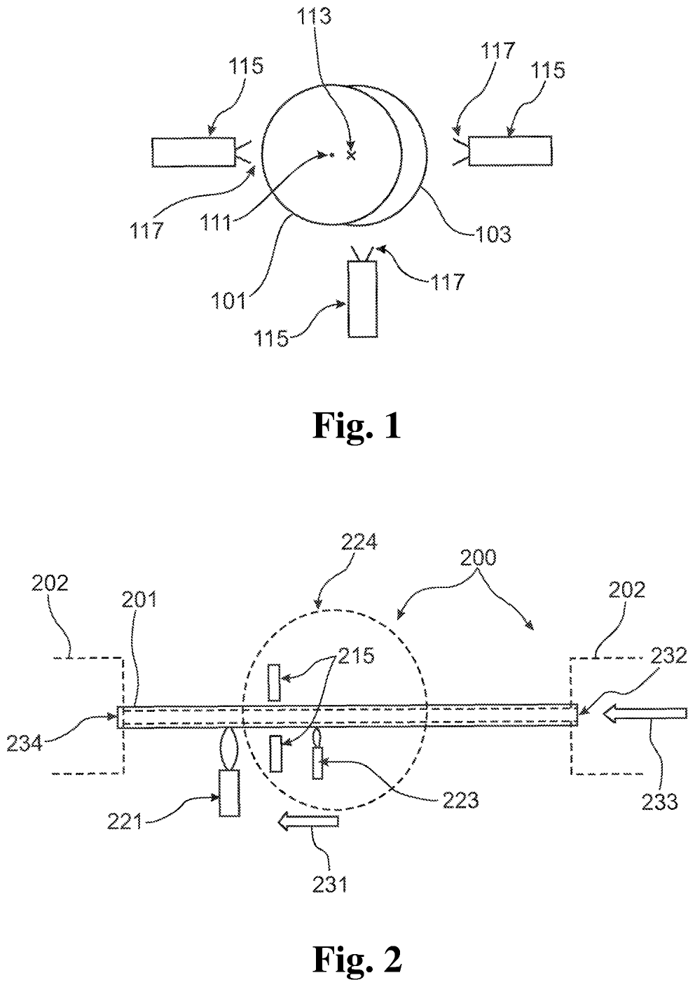

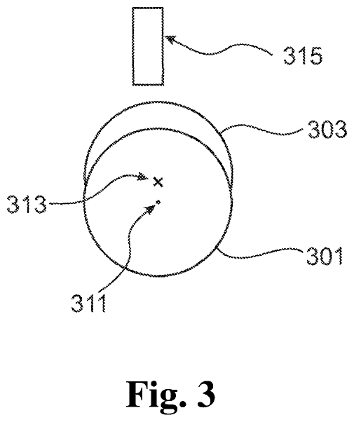

### DETAILED DESCRIPTION

In an embodiment, the present invention provides a device for aligning an impact of a tubular preform of an optical waveguide with a turning device, which imparts a rotation to the preform about an axis of rotation, a reactive gas supply, which supplies a reactive gas inside the preform, a burner device, which is associated so as to be displaceable in a longitudinal direction along the axis of rotation of the preform and applies a temperature to an outer surface of the preform by a coating flame, so that the reactive gas is partially deposited from the inside on an inner wall of the preform and melted to form a transparent layer, and an impact correction device, wherein the impact correction device is disposed in a first longitudinal section along the longitudinal direction to the coating flame and is arranged so that the preform is aligned by a first compressed air device, in particular a compressed air nozzle, by compressed air.

This method can be carried out without opening the enclosure and without the manual intervention of a plant operator. The results are thus also reproducible, and the beam quality of optical fibers drawn from the preform is significantly improved.

Contamination and defects of the outer surface of the preform can be prevented because the method is carried out essentially without contact (without mechanical contact).

The following terms should be explained:

An “impact” is in particular a deviation of the actual rotational axis of the preform from the rotational axis of the turning device and thus the turning lathe. The impact is sometimes also called “tube impact”. The impact can have varying degrees of intensity along the axis of rotation.

The “alignment” of the impact means that the real axis of rotation of the preform is brought closer to the axis of rotation of the turning device. In the ideal case, after alignment, the axis of rotation along the entire preform corresponds to the axis of rotation of the turning device. This is also referred to as “alignment” even if the impact is brought below a limit value.

A “preform” is in particular a tubular glass element, for example, made of quartz glass, which is coated by MCVD and then collapsed. An optical fiber (also known as a “glass fiber” or “optical waveguide”) is generally drawn from the preform by drawing, which can be used, for example, for optical communication. The preform has an “outer surface” and an “inner wall”.

The “outer surface of the preform” is the surface of the tubular preform which is essentially exposed to the coating flame and which is subjected to compressed air for alignment.

The “inner wall” of the preform encloses a hollow space in the preform, through which a reactive gas flows during the MCVD process. The inner wall and the cavity thus form the tube interior. In the MCVD process, the glass soot is deposited on this inner wall and melted to form a transparent layer. There is no longer a cavity nor an inner wall after the preform has collapsed.

This preform is generally clamped in a “turning device” (e.g., a “glassmaker turning lathe”). The turning device causes the preform to rotate around an axis of rotation of the turning device. The preform is generally clamped in the turning device therefor. A reactive gas is additionally introduced into the tube in a directed manner.

The “burner device” is, for example, an oxyhydrogen gas burner which, when the preform is rotated in the turning device, applies a temperature to the rotating preform at a defined distance with a defined flame temperature via the “coating flame”. Due to the rotation, which rotation is imparted by the turning device of the preform, the preform is homogeneously heated at the location of the burner device. The reactive gas is thereby heated and subsequently deposited as soot on the inner wall of the tubular preform. The burner device is generally arranged so as to be displaceable along the axis of rotation of the turning device. The beginning of the tube where the “reactive gas supply” introduces the reactive gas into the tubular preform is initially heated and moved to the end of the preform. The temperature of the burner device is then reduced, and the burner device is moved back to the starting point (tube beginning) in order to again heat the preform along its length while a reactive gas is supplied. As soon as the burner device passes over deposited soot, this soot is melted so that a transparent layer is formed on the inner wall of the preform.

The “longitudinal direction” is a direction which is substantially parallel to the axis of rotation of the turning device. A “longitudinal distance” is a distance which can be determined in the longitudinal direction.

The “impact correction device” is a device which applies a force to the preform by applying compressed air to the preform virtually without contact, and thus without mechanical contact, so that the real axis of rotation approaches the axis of rotation of the turning device. This can be done without opening the enclosure so that the temperatures remain defined during the MCVD process.

The “compressed air device” is in particular a compressed air nozzle which sprays a generally oil-free, inert gas, such as N₂, onto the outer surface of the preform.

“Compressed air” is commonly also referred to as “pressurized air” and generally includes compressed air or a compressed gas or gas mixture. The compressed air expands when the compressed air leaves the nozzle so that a directed pressure and thus a force is applied to a surface near the nozzle.

In an embodiment, the impact correction device can, for example, have a second compressed air device, a third compressed air device, a fourth compressed air device and/or additional compressed air devices, wherein the compressed air devices are in particular arranged equidistantly radially around the axis of rotation of the turning device.

The preform can be continuously aligned during the coating process, particularly in the case of a radially equidistant arrangement of the compressed air device. This can be achieved, for example, by arranging the compressed air devices at a defined longitudinal distance from the burner device and to all intents and purposes coupling them with the coating flame and thus the burner device during the coating process. The coupling can be done mechanically, for example, by arranging the preforms together on a carriage.

When using four compressed air devices, each compressed air device is offset by 90° relative to the next compressed air device. As long as these four compressed-air devices apply a constant air pressure onto the rotating preform, these compressed air devices act as a fixing “bearing” to all intents and purposes.

If an impact exists, the outer surface of the preform is “closer” to a compressed air device during rotation and thus experiences more intensive pressure, so that a directed force is created which reduces the impact of the preform. A simple constructive design for impact reduction can thus be realized.

In an embodiment, the compressed air devices can, for example, be aligned at a distance of between 1 mm and 20 mm, in particular between 2 mm and 6 mm, from an ideal surface of the preform.

The ideal surface is in particular the outer surface of the preform with no impact, so that the rotation axis of the turning device and the rotation axis of the preform are identical.

In order to compensate for any glass stresses exerted on the preform by the compressed air devices, the device may include a stress-relief burner, wherein the first compressed air device, the additional compressed air devices or all compressed air devices is or are arranged in the longitudinal direction between the burner device and the stress-relief burner. A stress-free preform can thus be produced.

In an embodiment, the device can, for example, comprise a coupling device, in particular a carriage, wherein the burner device, the impact correction device, and the stress-relief burner can be positioned in a defined manner relative to one another in the longitudinal direction via the coupling device. This can be realized, for example, by a purely mechanical coupling via a carriage or by respective individual carriages, which are adjusted relative to one another, for example, by means of open-loop or closed-loop control using drives.

In an embodiment, the first compressed air device, the additional compressed air devices, or all compressed air devices can, for example, apply a temporally continuous compressed air jet or a pulsed compressed air jet onto the outer surface of the preform. A different compressed air profile can thereby be applied to the outer surface of the preform using the compressed air devices.

An air jet generated by one or more of the compressed air devices may also have and impart different intensities and/or shapes to the preform.

A conical air jet emerging from a compressed air nozzle can, for example, apply a pressure profile to the outer surface of the preform that corresponds to a given impact because, when there is an impact, the outer surface of the preform approaches the compressed air nozzle during rotation, so that a higher pressure acts on the outer surface at the point of contact.

In order to apply a pulsed compressed air jet, for example, above the preform, to the outer surface of the preform, an impact measuring device can in particular be provided which measures the impact of the rotating preform and, on the basis of the measured values determined by the impact measuring device, applies pressure to the outer surface of the preform at the correct time, for example, via pulsed compressed air jets, so that the impact is reduced.

An “open-loop control” means setting a predefined value. In the case of “a closed-loop control”, a measured value is in particular fed back and a control value, such as the intensity, pulse duration, or pulse angle of the air pressure jet, is respectively set. A device can thus be provided with which the highest quality requirements for an optical fiber can be realized. Highly precise refractive index curves can in particular be achieved within the fiber.

The present invention provides a method for correcting the impact of a preform via a previously described device, wherein an impact is prevented or corrected via compressed air.

For the first time, the impact of a preform can thus be corrected contact-free, i.e., without mechanical contact.

In a corresponding embodiment of the method, the impact correction device can, for example, have a single compressed air device, and this single compressed air device impresses a rotation-dependent pulsed or intensity changed compressed air jet on the preform based on the measured value of the impact measuring device.

High quality fiber optic cables with a defined refractive index profile can thus be produced.

In an embodiment, the impact correction device can, for example, comprise two or more compressed air devices, which are arranged radially and in particular equidistantly around the preform, and the compressed air device continuously applies a compressed air jet to the preform.

The present invention is described in greater detail below based on exemplary embodiments as show in the drawings.

A MCVD device 200 includes a glassmaker's turning lathe 202, in which a tubular quartz glass 201 is clamped. This tubular quartz glass 201 forms the preform 201 to be coated. At the reactive gas inlet 232, a reactive gas is fed through the tubular preform in a flow direction 233. A main burner 221 and an auxiliary burner 223 as well as two air nozzles 215 are arranged on a carriage (the carriage not being shown in the drawings).

In order to coat the inside of the preform 201, the main burner 221 is moved via an oxyhydrogen gas flame from the inlet of the reactive gas inlet 232 in the direction of movement 231 via the carriage during the introduction of the reactive gas. In the process, the preform 201 is locally partially heated to approximately 1,800° C. to 2,000° C. The feed speed of the carriage is between 10 and 20 cm/min. At the tube end 234, the main burner 221 is brought down to a temperature of approximately 400° C. and moved back to the reactive gas inlet 232 via the carriage.

At the reactive gas inlet 232, the burner temperature is again raised to about 1,800° C. to 2,000° C. until reactive gases react and glass soot is formed downstream, which is heated in the hot burner zone and deposited on the inner wall of the preform 201 due to thermophoresis and then melted to a transparent layer by the following hot zones (and thus by the main burner).

This coating cycle is repeated until a required core cross-sectional area is deposited.

The burner temperature of the main burner 221 is then raised once again to approximately 2,200° C. to 2,300° C. so that the internally coated quartz glass tube 201 collapses to form a solid rod due to its surface tension.

During these processing steps, the quartz glass tube 201 rotates around its longitudinal axis so that the preform 201 (quartz glass tube 201) is uniformly partially heated locally.

An impact correction device 224 includes two air nozzles 215 arranged in a diametrically opposed arrangement and an auxiliary burner 223 mounted upstream (as seen from the flow direction 233). The air nozzles 215 and the auxiliary burner 223 are arranged on the carriage together with the main burner 221.

In the present case, the preform 103, 303 and thus the quartz glass tube have an impact at one time and place of rotation. A rotation axis 113, 313 of the quartz glass tube 103, 303 deviates from a rotation axis 111, 311 of the glassmaker's turning lathe 202. By means of a laser scanner (which is not shown in the drawings), the impact and thus the deviation of the rotation axis of the quartz glass tube 103, 303 from the rotation axis 111, 311 of the glassmaker's turning lathe 202 is determined.

The air nozzles 215 are additionally controlled so that if the outer surface approaches the respective air nozzle 215 due to the impact, the air nozzles 215 blow onto the quartz glass tube surface. This air jet causes the rotation axis 113, 313 of the quartz glass tube 103, 303, to again approach the rotation axis 111, 311 of the glassmaker's turning lathe 202 and an optimal preform 101, 301 is ideally formed.

Any resulting stresses in the quartz glass are subsequently removed by the auxiliary burner 223 when the carriage is moved.

In an alternative, only one pulsed air nozzle 315 is provided, which is arranged in an upper point, so that gravity and the pulsed air pressure together bring the rotating quartz glass tube 303 and thus its axis of rotation 313 closer to the axis of rotation 311 of the glassmaker's turning lathe 202.

In an alternative, the measuring of the impact via the laser scanner is dispensed with. Three air nozzles 115 are arranged around the quartz glass tube 103. The air nozzles 115 are each arranged at a distance of 90° to each other, wherein an upper air nozzle is dispensed with, so that the two lateral air nozzles 115 are 180° apart. An upper air nozzle is omitted in the present case because gravity causes a certain displacement effect.

The air nozzles 115 discharge a conical air jet 117. These continuously flowing air jets 117 bed the rotating quartz glass tube 103. If, for example, a lateral impact is formed, causing the rotation axis 113 of the quartz glass tube 103 to deviate from the rotation axis 111 of the glassmaker's turning lathe 202, the surface of the rotating quartz glass tube 103 will approach a respective air nozzle 115. Due to the conical air jet profile, as the surface of the quartz glass tube 103 approaches the air nozzle 115, the quartz glass tube 103 experiences a greater force, so that the rotation axis 113 of the quartz glass tube 103 approaches the rotation axis 111 of the glassmaker's lathe 202.

The compressed-air nozzles are then switched off and the auxiliary burner 223 is switched off and the quartz glass tube collapses to form a preform. A glass fiber is then drawn from this preform.

The present invention is not limited to embodiments described herein; reference should be had to the appended claims.

What is claimed is:

1-9. (canceled)

10. A device for aligning an impact of a tubular preform of an optical waveguide, the device comprising:
a turning device which is configured to rotate the preform about an axis of rotation;
a reactive gas supply which is configured to supply a reactive gas to an inside of the preform;
a burner device which is configured to be movably associated with the preform in a longitudinal direction along the axis of rotation of the preform and to control a temperature of an outer surface of the preform via a coating flame so that the reactive gas is partially deposited from the inside on an inner wall of the preform and melted to form a transparent layer; and
an impact correction device comprising a first compressed air device which is configured to apply compressed air, the impact correction device being arranged at a first longitudinal distance along the longitudinal direction from the coating flame so that the preform is aligned via the compressed air applied by the first compressed air device.

11. The device as recited in claim 10, wherein the first compressed air device is a compressed air nozzle.

12. The device as recited in claim 10, wherein the impact correction device further comprises at least one of a second compressed air device, a third compressed air device, a fourth compressed air device and additional compressed air devices.

13. The device as recited in claim 12, wherein the first compressed air device, and the at least one of the second compressed air device, the third compressed air device, the fourth compressed air device, and the additional compressed air devices are arranged equidistantly radially around the axis of rotation.

14. The device as recited in claim 12, wherein,
one of the first compressed air device, the second compressed air device, the third compressed air device, the fourth compressed air device, and the additional compressed air devices, or
more than one of the first compressed air device, the second compressed air device, the third compressed air device, the fourth compressed air device, and the additional compressed air devices, or
each of the first compressed air device, the second compressed air device, the third compressed air device, the fourth compressed air device, and the additional compressed air devices,
is or are arranged so that the first compressed air device, the second compressed air device, the third compressed air device, the fourth compressed air device, and the additional compressed air devices, as the case might be, has or have a distance between 1.0 mm and 20 mm, from an ideal surface of the preform.

15. The device as recited in claim 12, further comprising:
a stress-relief burner,
wherein,
the first compressed air device, or
the additional compressed air devices, or
each of the first compressed air device, the second compressed air device, the third compressed air device, the fourth compressed air device, and the additional compressed air devices,
is or are arranged in the longitudinal direction between the burner device and the stress-relief burner.

16. The device as recited in claim 15, further comprising:
a coupling device,
wherein,
at least one of the burner device, the impact correction device, and the stress-relief burner are configured to be positioned in a defined manner in the longitudinal direction relative to one another via the coupling device.

17. The device as recited in claim 16, wherein the coupling device is a carriage.

18. The device as recited in claim 12, wherein,
the first compressed air device, or
the additional compressed air devices, or
each of the first compressed air device, the second compressed air device, the third compressed air device, the fourth compressed air device, and the additional compressed air devices,
is or are configured to apply a temporally continuous air pressure jet or a pulsed air pressure jet to the outer surface of the preform.

19. The device as recited in claim 10, wherein the first compressed air device is further configured to apply a compressed air jet which has at least one of a different intensity and a different shape to the preform.

20. The device as recited in claim 19, wherein the impact correction device further comprises additional compressed air devices, each of which is configured to apply a compressed air jet which has at least one of a different intensity and a different shape to the preform

21. The device as recited in one claim 10, further comprising:
an impact measuring device which is configured to measure an impact value when the preform is rotating.

22. The device as recited in claim 21, further comprising:
a closed loop control device which configured so that the impact correction device is at least one of open loop controlled and closed loop controlled based on the impact value measured by the impact measuring device.
